(19) United States
(12) Patent Application Publication
(10) Pub. No.: US 2005/0288989 A1
(43) Pub. Date: Dec. 29, 2005

(54) Methods and systems for synchronizing distribution center and warehouse demand forecasts with retail store demand forecasts

(75) Inventors: Edward D. Kim, Toronto (CA); Patrick J. McDaid, Barrie (CA); Mardie S. Noble, Minesing (CA); Fred M. Narduzzi, Markham (CA)

Correspondence Address: James M. Stover;NCR Corporation, 1700 South Patterson Blvd., Dayton, OH, 45479-0001, US

(73) Assignee: NCR Corporation

(21) Appl. No.: 10/875,456

(22) Filed: Jun. 24, 2004

(51) Int. Cl. G06Q 30/00

(52) U.S. Cl. 705/10

(57) ABSTRACT

A method and system for forecasting product order quantities required to meet future product demands for a retail distribution center or warehouse. The method includes the steps of determining for each one of a plurality of retail stores, a long range order forecast for a product sold by said retail store; accumulating said long range order forecasts for said plurality of retail stores to generate a distribution center demand forecast for said retail distribution center; comparing said distribution center demand forecast with current and projected future inventory levels at said distribution center of said product; and determining from distribution center demand forecast and said current and projected future inventory levels suggested order quantities necessary for maintaining a minimum inventory level sufficient to meet said distribution center demand forecast for said product.

### CROSS REFERENCE TO RELATED APPLICATIONS

This application is related to the following co-pending and commonly-assigned patent application, which is incorporated by reference herein:
Application Ser. No. 10/737,056, entitled “METHODS AND SYSTEMS FOR FORECASTING FUTURE ORDER REQUIREMENTS” by Fred Narduzzi, David Chan, Blair Bishop, Richard Powell-Brown, Russell Sumiya and William Cortes; attorney docket number 11,332; filed on Dec. 16, 2003.

### FIELD OF THE INVENTION

The present invention relates to methods and systems for forecasting product demand for distribution center or warehouse operations; and in particular to tools for synchronizing distribution center or warehouse forecasting and replenishment systems with the forecasting and replenishment ordering systems employed by the retail stores served by the distribution center or warehouse.

### BACKGROUND OF THE INVENTION

Today's competitive business environment demands that retailers be more efficient in managing their inventory levels to reduce costs and yet fulfill demand. To accomplish this, many retailers are developing strong partnerships with their vendors/suppliers to set and deliver common goals. One of the key business objectives both the retailer and vendor are striving to meet is customer satisfaction by having the right merchandise in the right locations at the right time. To that effect it is important that vendor production and deliveries become more efficient. The inability of retailers and suppliers to synchronize the effective distribution of goods through the distribution facilities to the stores has been a major impediment to both maximizing productivity throughout the demand chain and effectively responding to the needs of the consumer.

In fact, most retail companies do not even consider changes in business operations or in consumer demand in building distribution center orders. Instead there has been a reliance on filling distribution facilities based on previous shipments or withdrawals in the hopes of maximizing future order fill rates.

This strategy has proven to be flawed because it relies on information specific to distribution center (DC) or warehouse expectations based on incomplete data and without consideration of expected consumer demand. Some limitations of current distribution methods are:
Reliance on similar order/withdrawal patterns;
Limited ability to respond quickly to changes in consumer demand;
Measures DC/warehouse fill rates versus filled customer demand and the impact of lost sales;
Inadequate translation of seasonality and promotional demand; and
Builds additional safety stock/fills DCs to allow for store pull/order fluctuations.

In the past few years, outstanding improvements in technology have allowed businesses to take advantage of high volumes of detailed data in the development of accurate forecasted consumer demand patterns. The ability to predict this demand down to the level of store/SKU (Stock Keeping Unit)/day well out into the future now offers leading retailers the ability to synchronize distribution center/warehouse plans with store needs through an accurate demand forecast.

Retailers now have the ability to change their business processes to take advantage of this opportunity and are shifting previous metrics and delivering some impressive returns around same store sales, customer satisfaction and inventory productivity improvements.

The potential benefits of a synchronized Store-DC/warehouse replenishment system are:
Ability to provide a collaborative forecast based on store-specific consumer POS demand;
Ability to respond quickly to changes in store operation policies;
Reduces store SKU stock outs, and calculates and corrects for lost sales when stock out conditions exist;
Accurate translation of store seasonality and promotional demand to the DC/warehouses; and
Reduces the level of safety stock in DC/warehouses and stores.

### SUMMARY OF THE INVENTION

It is an object of the present invention to provide a new and useful system and method for forecasting product order quantities required to meet future product demands for a retail distribution center or warehouse.

The method for forecasting product order quantities includes the steps of determining for each one of a plurality of retail stores, a long range order forecast for a product sold by said retail store; accumulating said long range order forecasts for said plurality of retail stores to generate a distribution center demand forecast for said retail distribution center; comparing said distribution center demand forecast with current and projected future inventory levels at said distribution center of said product; and determining from distribution center demand forecast and said current and projected future inventory levels suggested order quantities necessary for maintaining a minimum inventory level sufficient to meet said distribution center demand forecast for said product.

Still other aspects of the present invention will become apparent to those skilled in the art from the following description of various embodiments. As will be realized the invention is capable of other embodiments, all without departing from the present invention. Accordingly, the drawings and descriptions are illustrative in nature and not intended to be restrictive.

### BRIEF DESCRIPTION OF THE DRAWINGS

FIG. 1 provides an illustration of a product supply/demand chain from a supplier and manufacturer to a retail store and customer, and the barrier that currently exists in the demand chain between retailers and suppliers impeding their ability to coordinate the effective distribution of goods through the distribution facilities to the retail stores.

FIG. 2 is a graph providing a comparison between the relatively smooth product demand for a retail business and the “lumpy” demand seen by a distribution center and warehouse.

FIG. 3 is a high level block diagram illustration of a process for determining DC/warehouse demand from historical product shipments.

FIG. 4 is a high level block diagram illustration of a process for determining DC/warehouse demand from an accumulation of store point-of-sale (POS) data.

FIG. 5 is a high level block diagram illustration of a process for determining DC/warehouse demand from an accumulation of store suggested order quantity (SOQ) data.

FIG. 6 is a high level block diagram illustration of a process for determining DC/warehouse demand from a roll-up of store long range order forecasts in accordance with the present invention.

FIG. 7 is process flow diagram illustrating a synchronized DC/warehouse forecasting and replenishment process in accordance with the present invention.

FIG. 8 provides an illustration of a product supply/demand chain from a supplier and manufacturer to a retail store and customer following implementation of the Demand Chain Forecasting process described herein.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

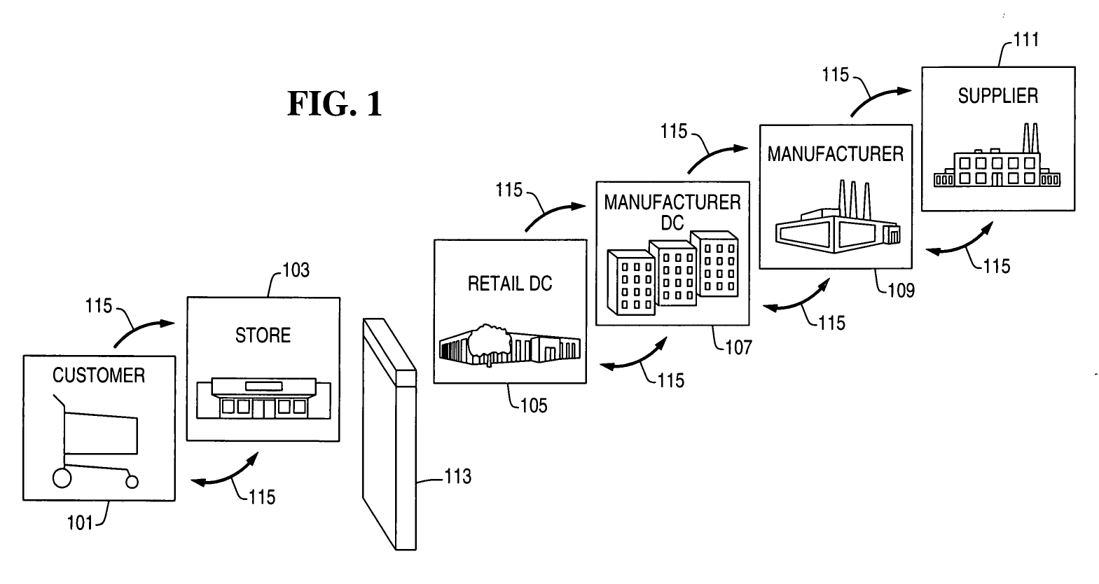

FIG. 1 provides an illustration of the retail demand/supply chain from a customer 101 to a retail store 103, retail distribution center/warehouse 105, manufacturer distribution center/warehouse 107, manufacturer 109 and supplier 111. An obstacle to efficient DC/warehouse forecasting and replenishment is the lack of visibility into historical and expected consumer demand, store effective inventory or changes to store operations. In FIG. 1, this obstacle is represented by a wall 113 between retail store 103 and retail distribution center/warehouse 105. Arrows 115 are used to illustrate communication between the demand/supply chain entities. Note the absence of communication between the retail store 103 and retail distribution center/warehouse 105.

In order to benefit from an efficient warehouse inventory system, retail businesses must synchronize the warehouse (DC/warehouse) replenishment system with the replenishment ordering system from their stores. The challenge here is to accurately translate the consumer demand from the stores to the distribution center (DC)/warehouse. Incorrect translations of the customer demand at the DC/warehouse will miscalculate inventory requirements resulting in stock-outs, over-stocks and inadequate service levels. These conditions cause businesses to incur higher inventory carrying costs, unnecessary markdowns and lost sales, eroding profits.

Thus, modeling and building a reliable Demand Chain Forecast is a significant step towards improved replenishment solutions and more efficient supply chains. There are several key issues in determining the Demand Chain Forecast needed for DCs/warehouses to execute accurate replenishment requirements:
The DC/warehouse demand leads the actual store consumer demand. This is to say the retail stores order products from the DC/warehouse in anticipation of consumer demand. Therefore the DC/warehouse forecast has to be able to look ahead further to create optimal vendor orders.
The DC/warehouse demand used is typically the shipments made to the numerous stores it supplies. However, the shipments are more discrete (less continuous) than the aggregate consumer demand at the stores. This is due to supply chain constraints such as multiple lead times, order points, pack sizes, transportation issues, and other logistical parameters needed to optimize the orders from vendor to DC/warehouse to stores.

Both of the issues above point to the existence of a “lumpy” DC/warehouse demand and require consideration in determining the most accurate DC/warehouse demand.

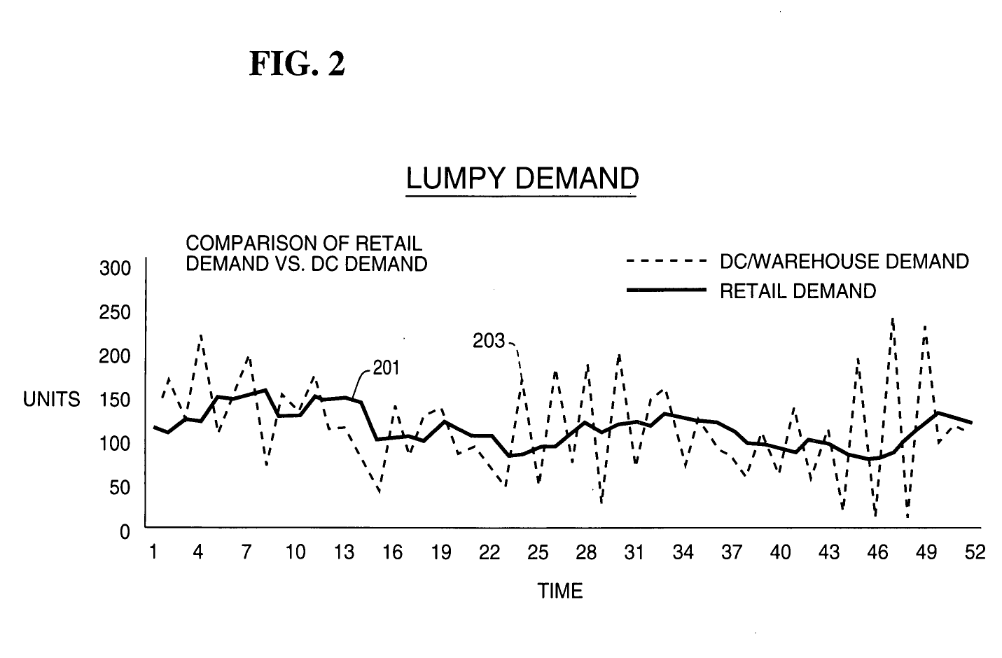

The graph shown in FIG. 2 provides a comparison between a retail business' relatively smooth retail demand and the “lumpy” demand seen by the distribution center and warehouse. The graph displays along the y-axis, the demand for a high volume product (SKU) sold at four retail stores during a 52 week period, shown left to right on the x-axis. Retail demand for the product is shown by graph 201 and DC/warehouse demand is shown by graph 203. The product (SKU) has the following logistics parameters associated therewith:
LT=1, RT=1, PSD=3, SL=90%, FcstErr=40%.
Where:
   LT=Lead Time;
   RT=Review Time;
   PSD=Planned Sales Days (Coverage);
   SL=Service Level Requirements; and
   FcstErr=Forecast Error Percentage

If a SKU is available at the DC/warehouse then it will be prepared and delivered to the stores at the next delivery cycle. In this example, the lead times from the DC/warehouse to store are relatively short, a few days, across all types of products. Since the lead times are short relative to the PSD, the safety stock calculation will be relatively low for most stores' orders. In this example, the safety stock was on average less than 3% of the stores' orders.

If a large number of stores are supplied by a single DC/warehouse and the logistics parameters are slightly different across many groups of stores, the aggregation of random peaks and valleys may smooth out the DC/warehouse demand curve. However, this random smoothing cannot be relied upon to generate accurate forecasts.

Notice in the example illustrated in FIG. 2 that the consumer demand at the four stores, illustrated by graph 201, is relatively smooth and continuous while the DC/warehouse demand is lumpy, shown by graph 203. Also, observe that very few of the valleys contained in graph 203 drop to zero, meaning that not all stores order on the same week nor skip the same week. The orders from the various stores are not synchronized since some stores may have higher effective inventory levels than others at any given time.

These store orders create the lumpy DC/warehouse demand. Using conventional linear forecasting methods can be ineffective with such non-linear behavior. For instance, a peak in the DC/warehouse demand may mean that many stores ordered on the same week. This will cause the adaptive ARS (Average Rate of Sales) calculation to increase next week's ARS, resulting in potentially higher forecasts. However, since the stores have just ordered, their effective inventories may be high and they may not order in the following weeks. This is evidenced by the lumpy demand illustrated by graph 203. Convention linear forecasting methods may create a situation where the forecast has been adjusted higher while the actual orders to the DC/warehouse may be lower, resulting in high forecast errors and consequently greater safety stock quantities at the DC/warehouse, on top of the safety stock requirements at the stores.

In addition, the peaks and valleys cannot be modeled effectively by the seasonality profile. For example, the seasonal DC/warehouse demand peak at week 4 will not necessarily occur at week 4 next year. For instance, the end-of-month orders may fall on week 5 next year. Therefore, an adaptive linear forecasting method will be ineffective with lumpy, non-linear demand at the DC/warehouse.

There are several methods that can be utilized to produce DC/warehouse demand forecasts. They are described below along with their advantages and disadvantages. Three methods for generating DC/warehouse demand forecasts are described below: (1) demand forecasts determined from historical shipment data, described under the heading “Shipments,” (2) demand forecasts determined from roll up of point-of-sale (POS) data, described under the heading “POS Roll Up,” and (3) demand forecasts determined from roll up of Suggested Order Quantities (SOQs), described under the heading “SOQ Roll Up.” A fourth, improved method for generating DC/warehouse demand forecasts from store order forecasts is described under the heading “Order Forecast Optimizer.”

1) Shipments

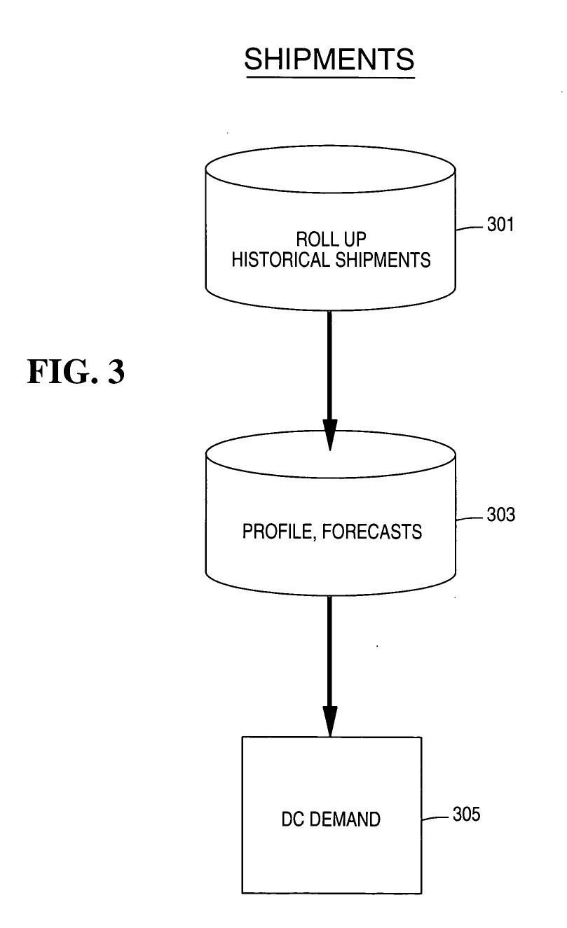

This process is illustrated in FIG. 3. Historical Withdrawal/Shipment data 301 is readily available and can be rolled up to produce reasonable Seasonal Profiles and Forecasts 303.

Advantages

Withdrawals/Shipments represent the historical DC/warehouse demand. Logical decision-making based on current business rules for: fill rates, capacity and minimums. Easy to get information from current data marts.
Automatically accounts for DC/Warehouse to store lead times.
The business understands this information and the metrics have been used to support decision making for some time. Best practices are already supported at the DC/warehouse and warehouse levels.
   Disadvantages
The historical shipments are not always indicative of what the store (new and existing) future forecasts and replenishment needs will be. Trend is not properly recorded by location or sum of locations. New locations are not accounted for in the Withdrawal/Shipment history and response to trend. In particular, increased demand is delayed, perpetuating inferior fill rate and lost sales.
The lumpy demand history tends to reduce the effectiveness of the forecasting system. Again, the high forecast error would increase the need for safety stock at the DC/warehouse in addition to the safety stock in the store orders.
Does not take into account store effective inventory or change in replenishment parameters.
Does not effectively account for future promotions, store openings and closures.
In the event that promotional and store events do not align year-over-year the demand requirement will be misrepresented.
   2) POS Roll Up

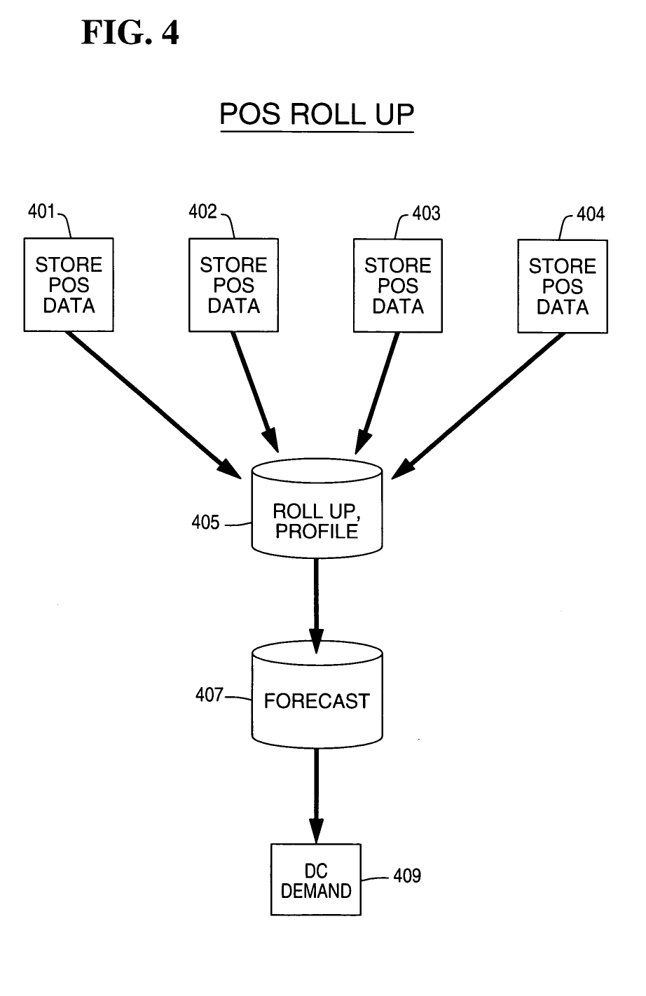

The process for rolling up POS data to determine DC/warehouse demand is illustrated in FIG. 4. SKU POS information from numerous store locations 401-404 is aggregated 405 and used to generate DC/warehouse profile and forecasts 407. The forecast is then offset by the average DC/warehouse-Store lead time to represent the order process from store to DC/warehouse 409.

Advantages

This is the simplest way to calculate the DC/warehouse demand. The POS data from the stores can be readily available in a data warehouse/data mart.
This available data can then be used to build profiles and order forecasts at the DC/warehouse level, with a minimum of effort, by a variety of automated solutions.
Promotions and store events can be accurately translated to DC/warehouse Demand Forecasts provided the promotional periods occur in the same time periods year over year.
If Teradata DCM Promotion Management solution is used, then promotions and store events can be accurately translated to DC/warehouse demand forecasts.
Combine orders with exception management processes for best results.
   Disadvantages
The DC/warehouse-Store lead time used to offset the forecast must be estimated by the user by trial and error, since there is no analytical method to compute the aggregate lead time.
This method does not adequately respond to the impact of changing effective inventory at the individual stores. If the effective inventory at most stores is high, due to unexpected slow sales, then the next orders may be relatively lower than expected, exposing the business to short supply as demand needs increase in the future.
   3) SOQ Roll Up

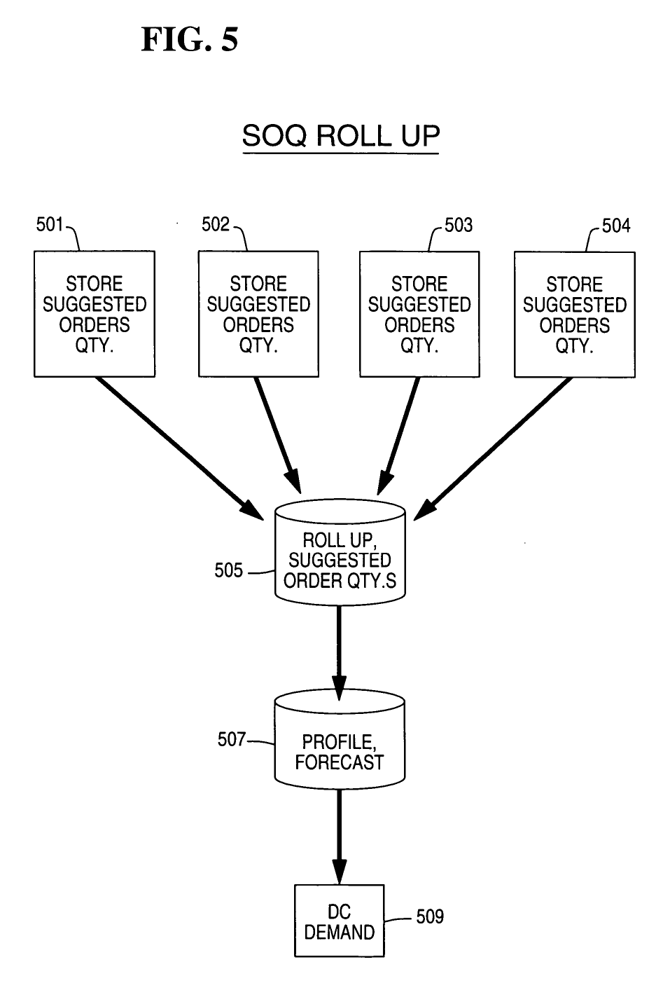

The process for rolling up SOQ data to determine DC/warehouse demand is illustrated in FIG. 5. Suggested Order Quantity information from numerous store locations 501-504 is aggregated 505 and used to generate DC/warehouse profile and forecasts 507.

Advantages

Takes into account lead times, seasonality and recent trends in both store and DC/warehouse requirements.
The SOQ represents true DC/warehouse demand from stores as it calculates demand for the stocking period (planned sales days). Considers lost sales where they exist and subtracts the effective inventory (on hand and on order) in building the correct store orders.
Considers each location's unique inventory management policies and strategies (trending, planned sales days of coverage, service levels, promotions, seasonality, minimum coverages, pack size and rounding) in building the SKU location forecast and orders.
More likely to deliver superior store support than methods based upon Shipments or POS roll-up, maximizing sales and increasing customer satisfaction. Likely to deliver better financial results (inventory, turns and sales) than Shipments or POS roll up methods.
Can be shared with Direct Store Delivery (DSD) vendors for more intelligent orders.
   Disadvantages
Although the aggregate consumer demand (from the retail stores) can be smooth and continuous, this “aggregate demand” at the DC/warehouse is “lumpy”, creating high forecast error and forcing solutions to factor additional DC/warehouse safety stock to cover inconsistent demand patterns. Increased safety stock at DCs drives up inventory investment without the reward of additional sales. In businesses that are highly dependent on freshness, fashion or seasonal items, the results will likely be increased waste or heavier than expected discounting to work through the excess inventory.
Since the DC/warehouse profiles are based on the aggregated store orders, the past store orders must be acquired or generated through a long simulation and seeding process. It may be difficult for some businesses to obtain the required processing power to perform a seeding operation for two to four years. In some cases it may require a powerful multi-node system to generate and save the results. These orders represent what would have been generated in the past, which will provide the demand for forecasting future orders.
Does not account for future promotions, store openings and closures.
Changing metrics and tools will challenge the culture of the business and its processes.
   4) Order Forecast Optimizer

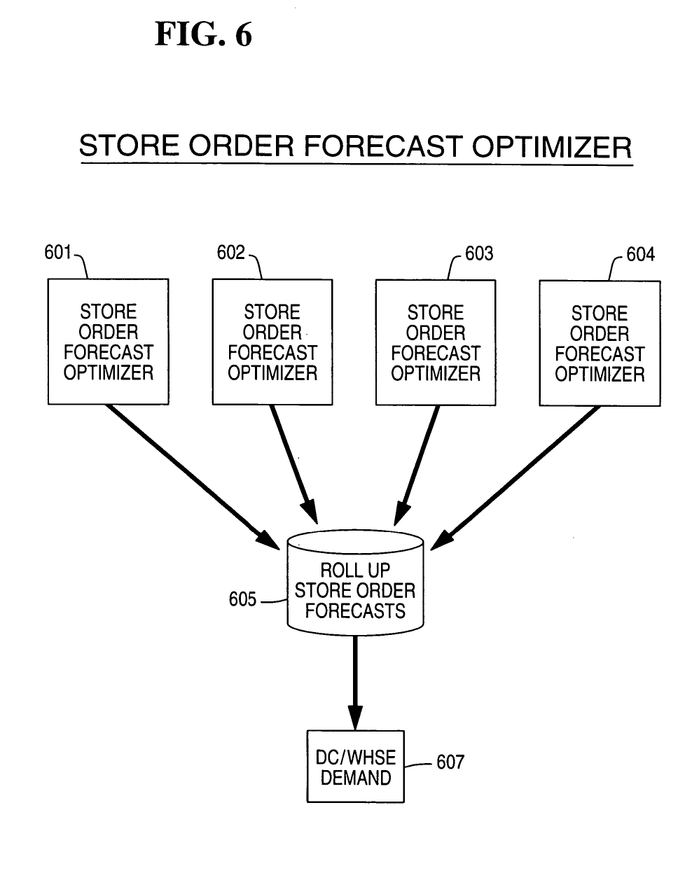

FIG. 6 is a high level illustration of a process wherein Store Order Forecasts determined for numerous retail stores 601-604 are accumulated 605 to create the DC/warehouse Synchronized Demand 607. Store Order Forecasts are determined through the process described in application Ser. No. 10/737,056, referred to above and incorporated by reference herein. The DC/warehouse Replenishment Orders will be executed considering all stores' time-phased needs net of Effective Inventory and applying the DC/warehouse's Lead Time, Planned Sales Days, Forecast Error and Service Levels.

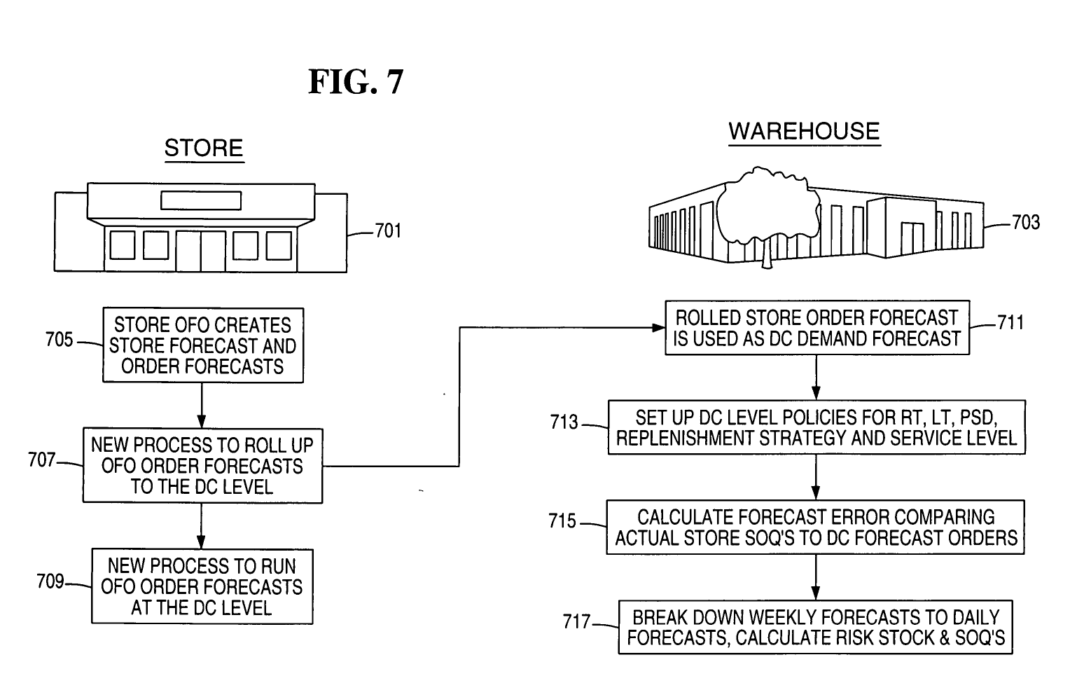

A synchronized DC/warehouse forecasting and replenishment process is illustrated in the process flow diagram of FIG. 7. Beginning at step 705, each retail store 701 supplied by warehouse 703 creates a store forecast and order forecast utilizing the Long Range Order Forecast system, also referred to herein as the Order Forecast Optimizer (OFO) system, described in application Ser. No. 10/737,056, referred to above. In step 707, the individual store OFO order forecasts are accumulated to the DC/warehouse level. This rolled-up OFO order forecast is provided to the DC/warehouse 703 for use as the DC/warehouse demand forecast, as shown in step 711.

In step 713, DC/warehouse level policies may be established for RT (Review Time from last time the replenishment system was run), LT (Lead Time from the order being cut to the delivery of product), PSD (Planned Sales Days, the amount of time the Effective Inventory should service the forecast demand), Replenishment Strategy, and Service Level. In step 715, forecast error is calculated comparing actual store Suggested Order Quantities (SOQs) to DC/warehouse forecast orders. Finally, in step 717, weekly forecasts are broken down to determine daily forecasts, calculate safety stock and SOQs. Safety Stock is the statistical risk stock needed to meet a certain service level for a given order quantity. The safety stock is a function of lead times, planned sales days, service level and forecast error.

The Order Forecast Optimizer described above and illustrated in FIGS. 6 and 7, provides the following advantages:
No need to model non-linear (lumpy) DC/warehouse demand forecasts. Simply use sum of Store Order Forecasts. This single version of the true synchronized need will be effective for service levels and support both DC/warehouse and store orders.
Accurate store demand forecasts responding to each location's needs and the latest trends are built into the time-phased orders. This method will deliver superior financial results (Average Inventory, Turns and Lost Sales) than the other three methods.
Changing order strategies are picked up through the time-phased order strategies (i.e. half of the store network has moved to be serviced from a different DC/warehouse for a period of three months and has had an order strategy implemented to increase days of supply by five days during changeover). The increase in additional days is picked up and phased into future store and DC/warehouse orders.
Changing logistics parameters such as LT, PSD or promotions will be accurately reflected in the new Order Forecasts from the store to DC/warehouse.
Visibility into the stores' effective inventory is reflected in the orders.

Of course, this process is dependent on Order Forecast Optimizer accuracy and performance. Since there will be errors between the forecasted orders and the actual orders, the forecast error will determine the safety stock required at the DC/warehouse. However, the forecast error and the safety stock will be significantly lower than other methods, such as those described above and illustrated in FIGS. 3, 4 and 5. For determination of optimal demand forecasts, two or more years of detailed store level demand (regular and promotional) is required, as well as accurate perpetual store inventories and frequent synchronized updating.

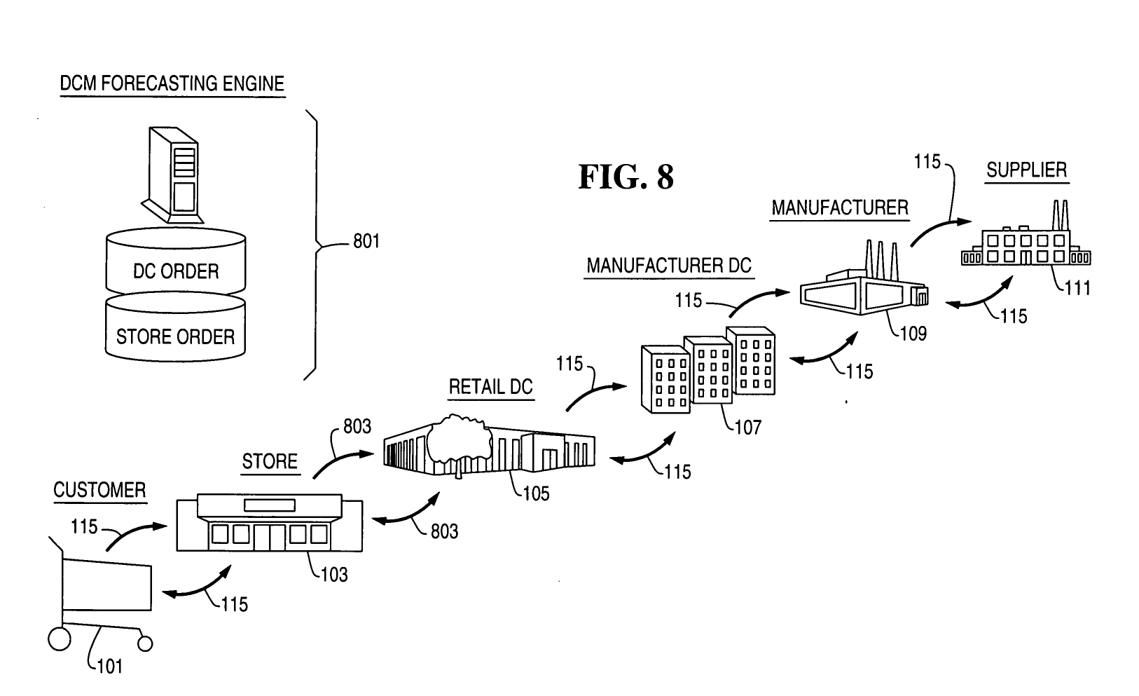

An illustration of the retail demand/supply chain from a customer 101 to a retail store 103, retail distribution center/warehouse 105, manufacturer distribution center/warehouse 107, manufacturer 109 and supplier 111 following implementation of the Demand Chain Forecasting process is provided by FIG. 8. Communication and visibility are provided between all entities in the demand/supply chain as illustrated by communication arrows 115 and 803.

The “Store Order Forecast Optimizer” method, shown in FIGS. 6 and 7 and described above, delivers the most accurate and responsive DC/warehouse forecasts for the highest level of automation, the least manual intervention and the best synchronization of orders from store to DC/warehouse. Having the ability to see the full supply/demand chain for every day decision-making and optimization provides a significant competitive advantage in planning and execution leading to improved profitability. Business benefits include:
Savings in Inventory Costs—Lower Risk Stock in the store and in the DC/warehouse due to better order fulfillment
Increased Sales Due to Reduction in Stock Outs—optimizes the entire Vendor to DC/warehouse to store replenishment cycle
Improved Customer Satisfaction—reduced Stock Outs leads directly to increased customer satisfaction
Optimized Supply Chain—more accurate Vendor Collaboration, consideration and better responsiveness to store logistics lead to a more efficient supply chain, reducing overall costs

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

1. A method for forecasting product order quantities required to meet future product demands for a retail distribution center, the method comprising the steps of:
determining for each one of a plurality of retail stores, a long range order forecast for a product sold by said retail store;
accumulating said long range order forecasts for said plurality of retail stores to generate a distribution center demand forecast for said retail distribution center;
comparing said distribution center demand forecast with current and projected future inventory levels at said distribution center of said product; and
determining from distribution center demand forecast and said current and projected future inventory levels suggested order quantities necessary for maintaining a minimum inventory level sufficient to meet said distribution center demand forecast for said product.

2. The method in accordance with claim 1, further comprising the step of:
adjusting said distribution center demand forecast to account for a planned promotion of said product occurring during a period of time contained within said distribution center demand forecast.

3. The method in accordance with claim 1, further comprising the step of:
comparing said distribution center demand forecast and suggested order quantities with actual distribution center demand and order information when available to determine an accuracy measurement of said method.

4. A system for forecasting product order quantities required to meet future product demands for a retail distribution center, the system comprising:
means for determining for each one of a plurality of retail stores, a long range order forecast for a product sold by said retail store;
means for accumulating said long range order forecasts for said plurality of retail stores to generate a distribution center demand forecast for said retail distribution center;
means for comparing said distribution center demand forecast with current and projected future inventory levels at said distribution center of said product; and
means for determining from distribution center demand forecast and said current and projected future inventory levels suggested order quantities necessary for maintaining a minimum inventory level sufficient to meet said distribution center demand forecast for said product.

5. The system in accordance with claim 5, further comprising:
means for adjusting said distribution center demand forecast to account for a planned promotion of said product occurring during a period of time contained within said distribution center demand forecast.

6. The system in accordance with claim 4, further comprising:
means for comparing said distribution center demand forecast and suggested order quantities with actual distribution demand and order information when available to determine an accuracy measurement of said system.
